(19) United States
(12) Patent Application Publication
(10) Pub. No.: US 2026/0186100 A1
(43) Pub. Date: Jul. 2, 2026

(54) Computer-implemented method for automatic control of false alarms; associated radar signal processing method and computer program

(71) Applicant: THALES, Meudon (FR)

(72) Inventors: Léo LEGRAND, MERIGNAC (FR); Philippe GOY, MERIGNAC (FR); Yoan VEYRAC, MERIGNAC (FR)

(21) Appl. No.: 19/415,103

(22) Filed: Dec. 10, 2025

(30) Foreign Application Priority Data
Dec. 27, 2024 (FR) FR2415335

(51) Int. Cl. G01S 7/41; G01S 13/72

(52) U.S. Cl. CPC G01S 7/411; G01S 13/726

(57) ABSTRACT

A method for automatic control of false alarms in a detection list corresponding to an output of a detection processing operating on a radar signal delivered by a maritime observation radar includes a tracking process enabling the identification of detections in the detection list likely corresponding to a spike, the tracking process being a hierarchical tracking process consisting, at the lowest level, of tracking spikes, and, at the highest level, of tracking groups of spikes, the tracking of spikes at the lowest level being performed conditionally at the highest level based on a common parameter characteristic of each spikes group track.

### BACKGROUND OF THE INVENTION

### Field of the Invention

The invention relates to the field of automatic control methods for false alarms, implemented in a radar signal processing chain for target detection, such as for maritime surveillance missions.

### Description of Related Art

A classic processing chain is based on the implementation of a detection module or detector, such as a constant false alarm rate detector-CFAR.

This detector is accompanied by one or more additional processing modules to confirm the detections (or blip) corresponding to an object of interest, among the primary detections coming from the detector (also called primary detections). For example, a kinematic extractor is implemented, which performs scan-to-scan processing, enabling filtering the primary detections over several revisits of a region of the radar field during a certain time interval to confirm the presence of an object of interest.

A detection gathers information derived from collected radar echoes, such as a position, an equivalent radar surface, etc. If the radar has a Doppler mode, a detection may also contain radial velocity information.

Downstream of these detection processes in the broad sense, the processing chain includes a target tracking module, whose purpose is to ensure the tracking over time of objects of interest from the confirmed detections. This module estimates the kinematic characteristics of a target, such as its position, speed, etc. This estimation is performed by an estimation algorithm of the Kalman filter type, for example.

The target tracking module produces a trajectory estimate, for example, for the attention of a radar system operator or the mission system. For example, this estimated trajectory is displayed on a human/machine interface of the system.

Among the detections (primary or confirmed), some of them actually correspond to targets, while others correspond to false alarms. These are power peaks attributed either to thermal noise or to radar echoes from clutter (ground, sea, atmospheric).

In the context of maritime surveillance, the sea clutter, consisting of radar signal backscatter by the sea surface, is a major source of false alarms.

In particular, echoes from sea clutter, whose power is comparable to that of objects of interest, appear on the sea surface.

Such an echo is called a “spike.”

The number of spikes actually depends on the sensitivity of the detector.

A spike appears as soon as a sea clutter echo shows a contrast greater than the detection threshold used by the detector. The contrast is a measure of the power of a distance/recurrence cell under test as compared to the surrounding environment, such as the average power around the cell under test.

This is all the more problematic when the detection threshold is low and the environment is dominated by thermal noise.

The spikes then compete with objects of interest in the processing that follows detection, specifically the target tracking.

Regulating the occurrence rate of false alarms is therefore a major challenge in radar processing design.

Various physical events can cause these spikes, such as waves breaking, waves breaking on shoals, water currents going in different directions, gusts of wind, etc. Although visible in the open sea, these phenomena are even more numerous in coastal areas.

Depending on the nature of the phenomenon causing spikes, they display specific persistence, appearance, stationarity and speed properties.

However, these properties display such variability that it remains difficult to design an adapted processing capable of separating a spike from a target, especially in the presence of atypical sea clutter.

Known false alarm control methods are based on a statistical modeling of the spike occurrence phenomenon. Some classic statistical models of sea clutter use a “heavy-tailed” distribution, such as the K distribution, or its more elaborate multi-parameter variants “KK” and “KA”, to represent the probabilities of spike occurrence.

The K distribution enables modeling an “average” sea clutter behavior, with an underestimation of the probability of spike occurrence and their power level.

The more elaborate variants (but more difficult to handle as they introduce more statistical parameters) enable better modeling of the occurrence of very high-power spikes.

It is then a matter of raising the detection thresholds to maintain the false alarm occurrence rate below a setpoint value.

However, this is done at the expense of detecting targets of interest.

Another approach consists of exploiting the kinematic coherence of targets as compared to spikes, which are assumed to be less persistent over time than the targets, the idea being to keep the detection thresholds at sufficiently low levels to enable the detection of targets of interest.

The kinematic extractor thus aims to exclude primary detections corresponding to spikes, based on a criterion complementary to that of the returned signal power.

It is therefore a matter of proposing alternative methods that enable the maintenance of radar detection capabilities by applying treatments and detection thresholds adapted to varied sea clutter environments, while controlling the overall constant false alarm occurrence rate.

The purpose of the invention is to address this problem.

### BRIEF SUMMARY OF THE INVENTION

To this end, the invention relates to a computer-implemented method for automatic control of false alarms in an input detection list corresponding to an output of a detection processing method operating on a radar signal delivered by a maritime observation radar, the method being characterized in that it implements a tracking process enabling the identification of detections in the detection list likely corresponding to a spike, the tracking process being a hierarchical tracking process consisting of tracking spikes at the lowest level, and of tracking spikes groups at the highest level, the tracking of spikes at the lowest level being performed conditionally at the highest level based on a common parameter characteristic of each spikes track group.

According to other advantageous aspects of the invention, the method comprises one or more of the following features, taken individually or in any technically possible combination:
the tracking process is performed by implementing a multi-group, multi-spike tracking algorithm, the output of said algorithm being a high-level estimated random finite set, said set specifically indicating a likelihood that a detection in the detection list corresponds to a spike;
the characteristic parameter is a spikes group speed and/or a spikes group wavelength;
a spike is a phenomenon on the sea surface that gives rise to one or more powerful radar echoes, these radar echoes leading to the generation of primary detections;
the tracking process is based on the assumption that spikes result from one or more wave trains;
the detection list is a list of primary detections, delivered at the output of the detection processing method, or a list of secondary detections, delivered at the output of another automatic false alarm control method;
delivering a list of spike detections, each detection in the list of spike detections having a likelihood greater than a predefined cutoff threshold;
a detection in the list of spike detections is characterized by at least one position and, advantageously, by a speed, a likelihood of corresponding to a spike, a cardinal of a group of spikes to which the considered detection belongs, and/or a persistence of a spike track to which the considered detection belongs.

The invention also relates to a computer program including software instructions that implement a method as defined above when executed by a computer.

### BRIEF DESCRIPTION OF THE SEVERAL VIEWS OF THE DRAWING(S)

The invention will become clearer upon reading the detailed description that follows, given solely by way of non-limiting example and made with reference to the drawings, wherein:

FIG. 1 is a schematic representation of a radar signal processing chain, in the form of functional modules, implementing the method according to the invention;

FIG. 2 is a schematic representation of an embodiment of a false alarm control method according to the invention;

FIG. 3 is a schematic representation illustrating the principle on which the method according to the invention is based;
FIG. 4 is a schematic representation of the group of spikes tracking algorithm implemented in the method of FIG. 2; and,

FIG. 5 is a graph of the probability density of the number of spike groups identified during the execution of the algorithm of FIG. 4.

### DETAILED DESCRIPTION OF THE INVENTION

In the present application, the term “spike” is used to designate a phenomenon on the sea surface that gives rise to one or more powerful radar echoes (i.e. one or more impulse peaks), these radar echoes being subject to as many detections by the radar signal processing chain detector (i.e. the generation over time of primary detections at the detector output). A spike here is therefore a detectable object (an elementary reflector), just like a target.

State-of-the-art processing does not consider sea clutter in its underlying physics. But assuming they result from one or more wave trains on the sea surface, spikes must display a certain correlation between them, such as in their speed.

Based on this assumption, it is then conceivable to introduce a false alarm control based on tracking a group of spikes.

In general, it is a hierarchical tracking process consisting of tracking spikes at the lowest level and of tracking groups of spikes at the highest level, the tracking of spikes at the lowest level being performed conditionally at the highest level that defines the value of a characteristic parameter of each spikes group.

Tracking spikes from primary detections enables estimating a common parameter value for each spike track, such as the speed value of each spike track.

Tracking spike groups from spike tracks enables estimating the common parameter value of each spike group, such as the speed value of each spike group.

A spike track belongs to a spikes group when the common parameter value of this spike track is close to the common parameter value of this spikes group.

In the preferred embodiment, this processing is performed by an algorithm that processes these different tracking levels simultaneously in an adapted statistical formalism. The inputs of this algorithm are the primary detections.

The grouping is not a binary decision: each primary detection belongs with a certain likelihood to a spikes group.

The output of this algorithm is a list of detections having a high probability of corresponding to spikes. It is called “list of spike detections” or, more simply, “spikes list” in the following.

This spikes list then enables filtering the list of primary detections to obtain a list of confirmed detections.

The processing chain integrating the method according to the invention therefore provides for two tracking spaces, that of targets of interest on the one hand and that of spikes on the other hand. The acquisition of information in one of the two tracking spaces enables feeding the tracking into the other space. In particular, when tracking the targets, it is advantageous to not consider primary detections known to correspond to spikes.

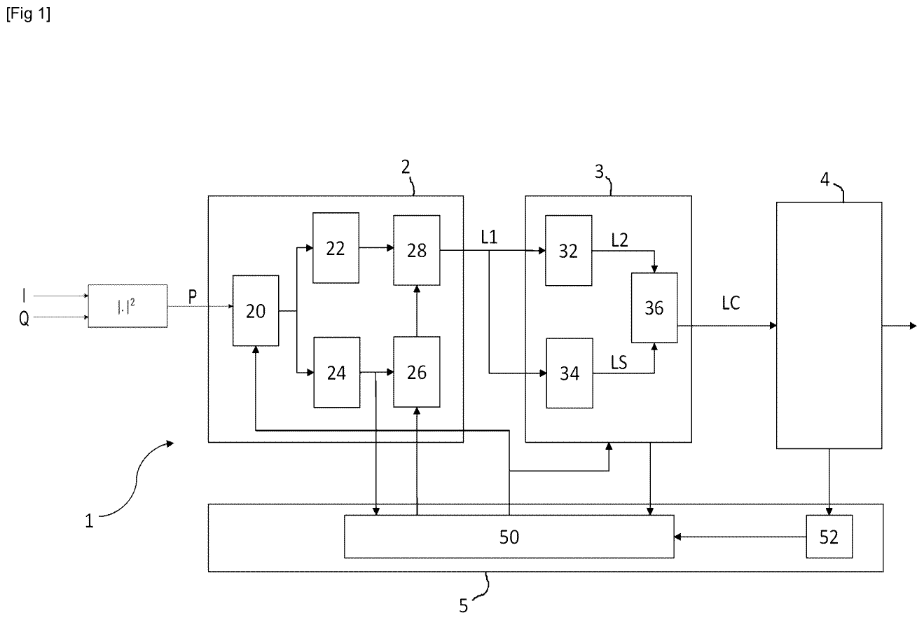

FIG. 1, in the form of functional blocks, represents a preferred embodiment of a radar signal processing chain 1 for the detection and tracking of targets, this processing chain being adapted to implement the method according to the invention.

The processing chain 1 is specific to the use of a radar in a maritime context.

It takes a raw radar signal as input, advantageously preprocessed (preprocessing module 6). The raw radar signal is generally composed of a complex signal represented by its in-phase component, noted I, and quadrature component, noted Q. Usual preprocessing consists of calculating the power of this digitized signal, noted P, after processing adapted to the radar waveform.

The processing chain 1 includes:
a detector 2, which takes the power P of the digitized signal as input, to produce a list of detections or primary detections, L1, at each sampling step.
a false alarm characterization module 3, which takes the list of primary detections L1 as input and delivers a list of confirmed detections, or confirmed detections, LC, as output; and,
a target tracking module 4, taking the list of confirmed detections LC as input to track one or more targets of interest.

Advantageously, the processing chain 1 includes a feedback loop, taking the form of a module 5 for calculating overall sea clutter indicators.

The detector 2 is, a constant false alarm rate detector-CFAR, for example.

The invention is not specific to a CFAR detector and applies following any detection processing delivering a list of primary detections.

In this case of a CFAR detector, as known per se, the detector 2 includes, for example:
an ambient noise averaging module 20;
a Z contrast calculation module 22;
a local noise characterization module 24;
an adapted threshold search module 26; and,
a thresholding module 28.

Specifically, the thresholding module 28 generates a primary detection when the contrast value Z of a distance/recurrence cell under test (as calculated at the output of module 22) is greater than the current detection threshold (as defined by the thresholding module 28).

A primary detection gathers a plurality of measured information. It is generally a position measurement, an equivalent radar surface measurement, a signal-to-clutter ratio measurement, an associated detection threshold value, etc.

Optionally, the plurality of information of a primary detection includes a radial velocity measurement when it is measurable on the waveform (i.e. when the radar system uses a Doppler mode).

The false alarm characterization module 3 implements one or more processes enabling the controlling of false alarms by filtering the list of primary detections to seek to confirm each of these detections, i.e. to increase the probability that a primary detection actually corresponds to a target.

For example, the module 3 includes a module 32, implementing a scan-to-scan processing to filter the list L1 of primary detections and to deliver a list L2 of secondary detections.

The scan-to-scan processing enables filtering the primary detections from the CFAR over several revisits, for example, resulting in the designation of confirmed detections.

The scan-to-scan processing implemented by module 32 is a kinematic extractor, for example.

According to the invention, module 3 includes a spikes group tracking module 34, specific to delivering a spikes list LS.

In the embodiment of FIG. 1, the module 34 takes the list L1 of primary detections as input. The modules 32 and 34 are therefore arranged in parallel to each other.

According to the invention, the module 3 includes a confirmation module 36, enabling filtering a list of detections based on the detections belonging to the spikes list LS, to obtain the list LC of confirmed detections.

In the embodiment of FIG. 1, the list of detections being filtered is the list L2 of secondary detections, but, in a variant, it could be the list L1 of primary detections.

At the output of the detection function in the broad sense (detection and false alarm control), the processing chain generally includes additional information processing functions such as target tracking, whose objective is to produce a visual for the attention of the radar system operator or mission system, for example.

Thus, as shown in FIG. 1, the processing chain 1 includes a target tracking module 4 whose purpose is to ensure the tracking of objects of interest over time. The target tracking, by filtering (of the Kalman filter type), can also ensure the estimation of the kinematic characteristics of target tracks, i.e. objects of interest such as position and speed.

The module 5 includes a module 52 for calculating target density indicators from information provided by the target tracking module 4, for example.

The module 5 includes a module for calculating overall sea clutter indicators 50, for example, from information provided at the output of the target density indicator calculation module 52, the local noise characteristics module 24 and, advantageously, the false alarm calculation module 3.

The overall clutter-related indicators calculated by the module 50 are transmitted to the ambient noise averaging module 20, the adapted threshold search module 26 and/or the false alarm calculation module 3, for example.

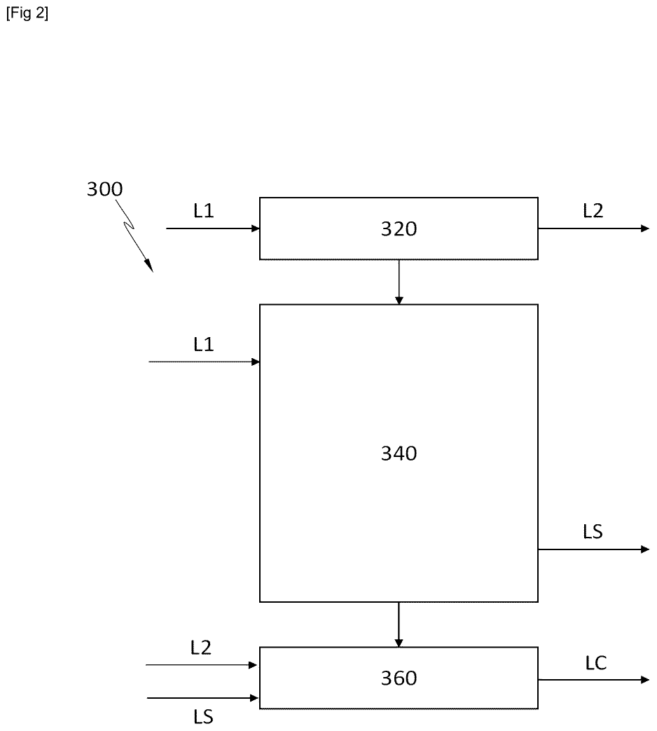

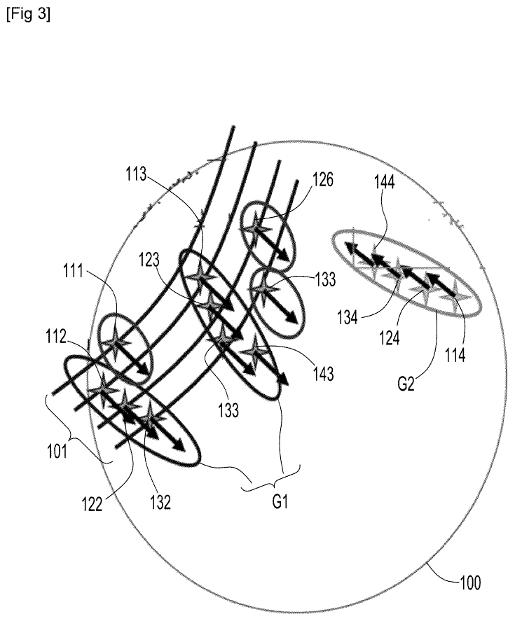

FIGS. 2 and 3 illustrate the spikes group tracking algorithm on which the method according to the invention is based.

FIG. 2 represents a method 300 for automatic false alarm control, in the form of blocks. It corresponds to the execution of the module 3 of FIG. 1.

FIG. 3 illustrates a geographical area 100, which is observed by the radar system at four successive moments, the results of these four observation moments being represented superposed in FIG. 3.

A wave train 101 is propagated through the geographical area 100.

Some of the waves of the wave train 100 break during the observation period, causing the appearance of spikes.

For example, at the first moment, primary detections 111, 112, and 113 are detected, which actually correspond to spikes.

For example, at the second moment, primary detections 122, 123, and 126 are detected, which actually correspond to spikes.

For example, at the third moment, primary detections 132, 133, and 135 are detected, which actually correspond to spikes.

For example, at the fourth moment, a primary detection 143 is detected, which actually corresponds to spikes.

Meanwhile, a target of interest is displayed in the geographical area 100. Primary detections 114, 124, 134, and 144, actually corresponding to this target, are generated at the respective first, second, third, and fourth moments of the observation period.

In the preferred embodiment, presented here in detail, the method 300 begins with a kinematic filtering step 320.

It corresponds to the execution of the module 32.

It consists of applying a kinematic extractor-type algorithm to the detections of the first list L1. It is a Kalman filter-type algorithm, for example.

For each detection in the list L1 at the current moment, the kinematic extractor uses a filter that estimates the tracks of hypothetical targets, tracks opened during previous moments from the detections of lists L1 at previous moments. If, during a certain time interval, a track has been fed by a certain number of detections from previous moments and the detection of the current moment, then this detection at the current moment is retained and stored in the list L2.

Moreover, the detections of the first list L1 at the current moment enable updating the filter for the next iteration of the kinematic estimator.

Thus, the tracks that do not persist over a small number of radar revisits are not retained. The second list L2 therefore contains detections that persist over at least a number of scans (typically two turns). These detections more certainly correspond to a target.

In the situation illustrated in FIG. 3, this amounts to removing isolated detections, such as detections 111, 126, and 135.

The method 300 continues with a spikes group tracking step 340. It corresponds to the execution of the module 34 of FIG. 1.

It consists of applying a spikes group tracking algorithm to the detections of the first list L1 to obtain a spikes list LS.

The spikes group tracking algorithm is a filter that estimates, from detections acquired at past moments, the probability that a detection acquired at the current moment, such as detections 141 and 144, actually corresponds to a spike. The detections acquired at the current moment enable updating the estimator for the next iteration of the step 340.

The step 340 exploits the values of a common parameter between several primary detection tracks, with these detections being acquired at different moments, to perform groupings between the primary detections and thus define one or more groups of spikes.

Thus, in FIG. 3, the spikes group tracking algorithm first tracks the spikes. The spike tracking is performed by estimating the speed of a spike associated with the track and estimating the position of this spike at the current moment, a detection detected at the current moment confirming this spike track when its position is close to the estimated position of the spike.

Thus, for example, a spike track was opened with the detection 112 then confirmed with the detections 122 and 132. The speed value of this object of interest is estimated from the positions of the different detections constituting this spike track.

For example, a spike track was opened with the detection 113, then confirmed with the detections 123 and 133. The speed value of this object of interest is estimated from the positions of the different detections constituting this spike track.

For example, a spike track was opened with the detection 111, but closed, since no primary detection could be associated with this track at subsequent observation moments.

For example, a spike track was opened with the detection 114, then confirmed by the detections 124 and 134 at subsequent moments. The speed value of this object is estimated from the positions of the different detections constituting this spike track.

Then, the spikes group tracking algorithm tracks the groups of spikes. The tracking is performed by estimating the speed of a spikes group at the current moment, a spike track at the current moment confirming this spikes group track when its speed is close to the estimated speed of the spikes group.

Thus, for example, a spikes group track G1 is opened with the spike tracks 112, 122, and 132 on the one hand and 113, 123, 133 on the other hand.

At the next moment, upon acquiring a new detection such as the detection 143, a likelihood calculation between the characteristics of this new detection and those of the spikes group enables evaluating the probability that this new detection belongs to the spikes group G1 and therefore that it is indeed a spike rather than a target.

Regarding the detections actually corresponding to a target, the detections 114, 124, 134, and 144 are grouped into a second spikes group G2.

This enables noting that, in this method, the logic is reversed compared to target tracking, since the spikes are now the tracked objects of interest, while the targets are part of the false alarms from the point of view of multi-group multi-spike tracking.

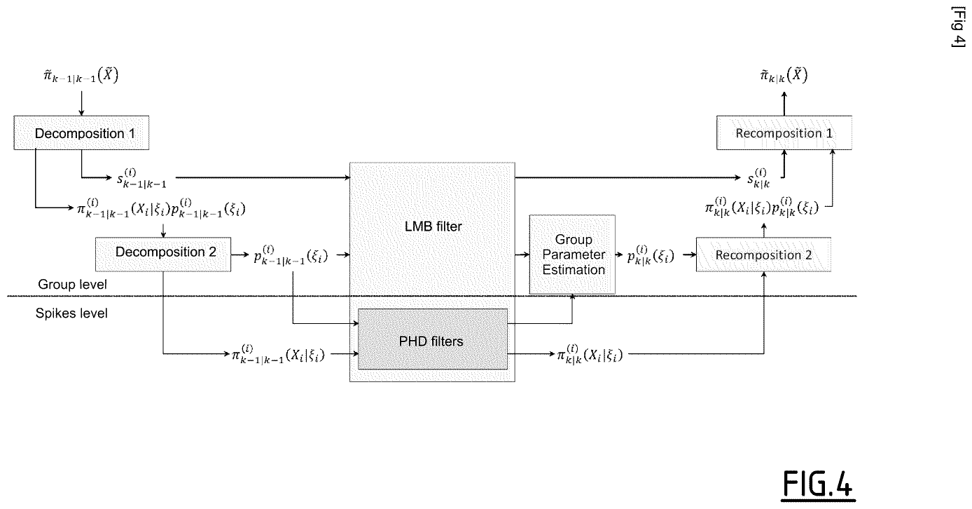

The spikes group tracking method associates a likelihood of being a spike with each detection in list L1. In fact, the spikes group tracking produces an estimated random finite set as will be described in more detail in relation to FIG. 4. The spikes group tracking method performs a probabilistic association where all detections can feed all tracks.

By extracting all or part of the information from this estimated random finite set, the spikes list LS at the output of step 340 is advantageously constituted.

The spikes list LS is the list of primary detections L1 that correspond with a high probability to spikes, for example. In other words, the spikes group tracking method associating a likelihood of being a spike with each detection in list L1, a cutoff probability is defined such that detections in list L1 with a likelihood below this cutoff probability are not retained in the spikes list and those with a likelihood equal to or above this cutoff probability are retained in the spikes list.

In a variant, the spikes list comprises all primary detections from list L1 and associates an additional attribute corresponding to the likelihood of being a spike as calculated by the spikes group tracking method.

Optionally, other information is added to each detection in the spikes list LS, such as persistence information of the spike track to which the considered detection belongs, or the cardinal of the spikes group to which the considered detection belongs.

The method 300 includes a final confirmation step 360 of the information obtained at the output of the kinematic extraction and spikes group tracking steps to obtain a list of confirmed detections LC.

The fusion step corresponds to the execution of the confirmation module 36.

For example, the second list of detections L2 is filtered to remove detections appearing in the spikes list LS and thus obtain a list of confirmed detections LC. Each detection in this list corresponds to a target with a higher probability.

Other confirmation criteria can be implemented in this step.

For example, the confirmation module 36 can seek to identify the detections actually corresponding to spikes and those actually corresponding to a target in the spikes list LS.

For this, a first criterion consists of considering the cardinal of the groups of spikes at the output of the module 34. If the cardinal of a spikes group is equal to one, i.e. if a group contains only one spike track, then the probability that the detections associated with this spikes group actually correspond to a target is high. The situation that escapes this criterion would be a set of targets moving parallel with roughly the same speed (case of ships traveling along a navigation rail).

For this, a second criterion consists of considering the persistence of a spike track. Indeed, a target persists over longer durations than a wave source of spikes. A spikes group is filled with unitary estimators that spend their time being born and dying, according to the persistence time of a spike track. The spikes group persists, even in the temporary absence of a spike track, but “limited duration” tracks appear and disappear constantly when they actually correspond to spikes. Thus, the persistence of a spike track over a long duration (for example, more than ten successive scans) increases the probability that the detections of this spike track actually correspond to a target.

For this, a third criterion consists of considering the sector of the radar system's observation field where spikes are detected. Indeed, the spikes are mostly distributed in the upwind sector over the entire wave fronts. Thus, the probability that the detections associated with a spikes group are outside this sector increases the probability that these detections actually correspond to a target.

After identifying the spikes, the corresponding detections can be rejected from the set of detections used to feed the target tracking method.

While the algorithm has been presented above in a “literary” and therefore approximate manner, the following presents the mathematical formalism on which the algorithm is based to estimate the probability that a primary detection at the current moment is a spike.

At a current moment, a high-level estimated random finite set \tilde{X} is defined as the input variable of the spikes group tracking algorithm. By “high level,” we mean the highest level of the hierarchy, i.e. the spikes group level.

At the current moment, the high-level estimated random finite set \tilde{X} groups a plurality of groups of spikes

$$[ \begin{matrix}{X}_{i} \\ {ξ}_{i}\end{matrix} ] ,$$

with i an integer between 1 and \tilde{m}:

$$\tilde{X} = \{ [ \begin{matrix}{X}_{1} \\ {ξ}_{1}\end{matrix} ] , … , [ \begin{matrix}{X}_{i} \\ {ξ}_{i}\end{matrix} ] , … [ \begin{matrix}{X}_{\tilde{m}} \\ {ξ}_{\tilde{m}}\end{matrix} ]$$

The total number \tilde{m} of groups of spikes is represented through a distribution of probability \tilde{ρ} on the cardinal of \tilde{X}. We note it:

$$\tilde{ρ} ( \tilde{m} ) = P ( Card ( \tilde{X} ) = \tilde{m} )$$

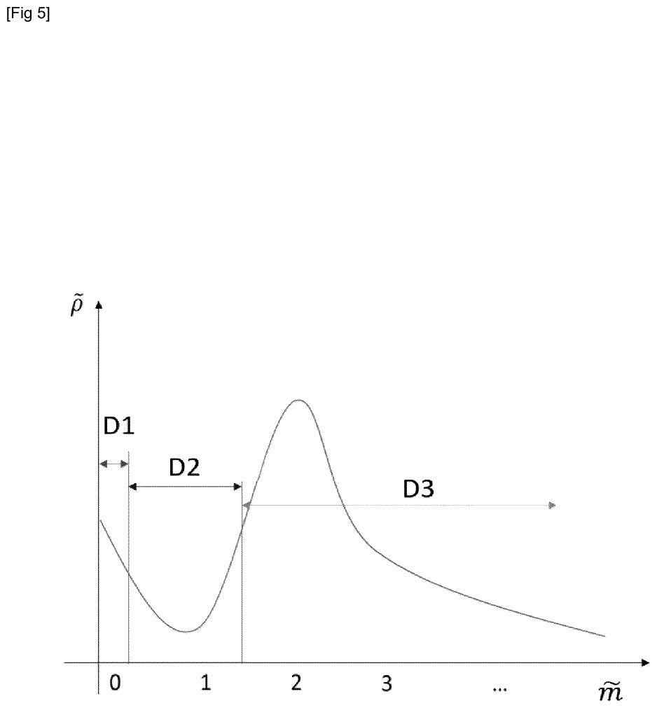

An example of the distribution of probability \tilde{ρ} is given in FIG. 5.

Typically, the number of groups of spikes is equal to the number of wave trains on the sea surface within the field observed by the radar system.

A spikes group

$$[ \begin{matrix}{X}_{i} \\ {ξ}_{i}\end{matrix} ]$$

associates a low-level estimated random finite set Xᵢ and one or more group parameters ξᵢ. By “low level,” we mean the lowest level of the hierarchy, i.e. the spikes level.

Xᵢ is a set of vectors x^{(i,j)}, j an integer between 1 and nᵢ:

$${X}_{i} = \{ {x}^{( i , 1 )} , … , {x}^{( i , j )} , … , {x}^{( i , {n}_{i} )} \}$$

Each vector x^{(i,j)} corresponds to a spike track opened at the current moment.

The low-level estimated random finite set Xᵢ groups nᵢ tracks.

A group parameter ξᵢ is a common characteristic of the group of index i. It is the characteristic speed vᵢ of the spikes group, for example.

At a current moment k, the measurements, i.e. the information associated with the primary detections (for example, from the first L1 or the second L2 according to the implementation variant), can be gathered in the estimated random finite set Zₖ:

Zₖ={Z_{k,1}, . . . , Z_{k,p}} with p ∈ [symbol] ,

where p is the number of measurements at the current moment k comprising the objects of interest and the false alarms.

Z_{k,1} is the measurement vector associated with the detection of rank 1 in the list L1

A multi-group density \tilde{π}(\tilde{X}) is defined, as well as the associated Bayesian filtering. The density \tilde{π}(\tilde{X}) is predicted, then updated in the filtering.

The multi-group density at the previous moment k−1, \tilde{π}_{k-1|k-1}(\tilde{X}ₖ₋₁), is first predicted to obtain the density \tilde{π}_{k|k-1}(\tilde{X}ₖ).

The use of the set of measurements Zₖ enables updating this prediction to obtain the density at the current moment k, \tilde{π}_{k|k-1}(\tilde{X}ₖ).

The multi-object density encapsulates and propagates the different hypotheses on the number of groups and the estimated value of their respective group parameters.

The filtering is a variant of the multi-group multi-target Bayesian filtering, for example, presented in the document Leo LEGRAND, Audrey GIREMUS, Eric GRIVEL, Laurent RATTON, Bernard JOSEPH, and Clément MAGNANT, “A hierarchical LMB/PHD filter for multiple groups of targets with coordinated motions”, in 21^{st} International Conference on Information Fusion, 2018, to take into account specifically the variation in the number of groups at each moment, i.e. the probability distribution \tilde{ρ}(\tilde{m}).

FIG. 4 illustrates the Bayesian filtering implemented by showing the hierarchical structure of the algorithm. According to this hierarchy, it is a matter of decomposing the multi-group density at moment k−1 \tilde{π}_{k-1|k-1}(\tilde{X}ₖ₋₁).

This decomposition highlights a probability of existence of the i^{th} spikes group, since the estimated cardinal \tilde{m} varies over time:

$${s}_{k - 1 \vert k - 1}^{( i )}$$

Assuming the existence of the i^{th} spikes group, characterized by an estimated group parameter ξᵢ, the i^{th} spikes group is then represented by:

$${π}_{k - 1 \vert k - 1}^{( i )} ( {X}_{i} \vert {ξ}_{i} ) {p}_{k - 1 \vert k - 1}^{( i )} ( {ξ}_{i} )$$

This representation enables a second decomposition separating the probability density

$${p}_{k - 1 \vert k - 1}^{( i )} ( {ξ}_{i} )$$

on the group parameter ξᵢ, which reflects the uncertainty around the estimated value of this group parameter and the multi-spikes density at the past moment

$${π}_{k - 1 \vert k - 1}^{( i )} ( {X}_{i} \vert {ξ}_{i} ) ,$$

conditionally defined to the group parameter ξᵢ.

The different components,

$${s}_{k - 1 \vert k - 1}^{( i )} , {π}_{k - 1 \vert k - 1}^{( i )} ( {X}_{i} \vert {ξ}_{i} ) , {p}_{k - 1 \vert k - 1}^{( i )} ( {ξ}_{i} )$$

are then subject to a prediction and an update taking into account the measurements at the current moment Zₖ.

This prediction implements a Bayesian filter incorporating a plurality of PHD filters (“probability hypothesis density filter”) as described in the previously cited article.

The PHD filters are responsible for predicting and updating the tracking of groups, i.e.

$${π}_{k - 1 \vert k - 1}^{( i )} ( {X}_{i} \vert {ξ}_{i} ) to {π}_{k \vert k}^{( i )} ( {X}_{i} \vert {ξ}_{i} ) .$$

There is one PHD filter per group.

For each group, by combining all the speed estimates of the spikes in the group, the density on the group parameter is estimated, i.e.

$${p}_{k \vert k}^{( i )} ( {ξ}_{i} ) .$$

The filter enabling this estimation is the highest hierarchical level filter, the LMB (“labeled multi-Bernoulli”) filter in the example.

Finally, depending on whether the group hypothesis i has been fed, plausibly by Zₖ, the probability of existence of the group i is updated to obtain

$${s}_{k \vert k}^{( i )} .$$

The multi-group multi-spikes density at the current moment \tilde{π}_{k|k}(\tilde{X}ₖ) is then obtained by a second re-composition, enabling obtaining

$${π}_{k \vert k}^{( i )} ( {X}_{i} \vert {ξ}_{i} ) {p}_{k \vert k}^{( i )} ( {ξ}_{i} )$$

from

$${π}_{k \vert k}^{( i )} ( {X}_{i} \vert {ξ}_{i} ) and {p}_{k \vert k}^{( i )} ( {ξ}_{i} ) ,$$

then by a first recombination, enabling obtaining \tilde{π}_{k|k}(\tilde{X}ₖ) from

$${π}_{k \vert k}^{( i )} ( {X}_{i} \vert {ξ}_{i} ) {p}_{k \vert k}^{( i )} ( {ξ}_{i} ) and {s}_{k \vert k}^{( i )} .$$

It should be noted that spike tracks persist within the spikes group tracking. Each spike track is fed by all detections at the current moment. In practice, unlikely cases are not fully calculated.

An output of the algorithm is the calculation of the distribution on the number of groups \tilde{ρ}(m). This distribution can be interpreted as an indicator of the nature of sea clutter: calm sea (field D1 of FIG. 5), oceanic clutter (field D2 of FIG. 5), or atypical clutter (field D3 of FIG. 5).

The interpretation of the nature of sea clutter can have concrete implications. The presence of atypical clutter, in particular, can lead to adjusting the parameters of other radar processing chains, specifically via module 5, the adjustment of the detector 2 parameters.

The spikes group tracking can be used alone or in combination with other processing, specifically classic recognition and classification approaches, to integrate information on the nature of echoes enabling strengthening radar processing and/or false alarm control in a target detection application.

The spikes group tracking can be placed in parallel and/or in series with these other treatments.

The present invention can interface with any chain featuring pre-detections or primary detections and confirmations of these detections or confirmed detections, provided it concerns filtering spikes.

The invention has applications in systems embedded on aircraft, surface ships, submarines, satellites, and more generally any platform requiring target detection/identification against a sea clutter background.

The parameter used to group spikes stems from the underlying physical phenomenon of their formation. Since spikes are consecutive to waves that themselves are part of one or more wave trains, speed and/or period constitute exploitable parameters for grouping.

In the case where the common parameter used as a grouping criterion is the period (or wavelength) of the wave train, it is considered that the wave fronts are generally orthogonal to the wave train's speed vector.

However, the shape of the wave front can be a straight line perpendicular to the wave train's speed vector in the case of a plane wave front (established phenomenon) or a sort of arc in the case of a spherical wave front (transient phenomenon).

The positions of the detections in list L1 are first projected by group onto the axis defined by the speed vector of the spikes group.

If a pattern appears with detection aggregates at certain points on the axis, the hypothesis of a plane wave front can be validated. The wave period can be estimated by the distance between the detection aggregates on this axis.

If not, the detection projection operation is complexified. Projections can be performed on several axes, corresponding to the local direction of the spikes group' speed vector. The wave front is thus locally a straight line, and the wave train period can then be estimated locally. The local periods are then recombined to obtain an overall period estimate.

The projection operation serves to initialize the common wavelength parameter ξᵢ used in the group tracking through the density

$${p}_{k \vert k}^{( i )} ( {ξ}_{i} ) .$$

Based on this density hypothesis, the tracking calculates the likelihood of the measurements, i.e. the positions of the detections in L1, using the projection models defined above.

It should be noted that the grouping parameter value is estimated during the spikes group tracking.

In the case of speed, a wave breaks at the moment k, and gives a first measured position detection (x1, y1) on the sea surface. At the moment k+1, this wave gives a second measured position detection (x2, y2).

The spikes group tracking algorithm enables obtaining a more precise estimate than this rough calculation.

If a second wave break is considered, with measurements (x1′, y1′) and (x2′, y2′), the respective speed vectors [vx, vy] and [vx′, vy′] are very close.

By multiplying the measurements, sometimes over N revisit moments, a spikes group speed is estimated.

The use of a radar in Doppler mode provides a relative radial speed measurement, which can feed the speed estimation, but which must be well differentiated from the estimated speed of the phenomenon causing the spikes.

The “series” of measurements do not occur simultaneously in the sense that a wave break can occur in a given time interval and another wave break can occur in another interval. However, the speed vectors are close, and the group tracking algorithm enables identifying them in the same group.

1. A computer-implemented method for automatic control of false alarms in a list of detections, the list of detections corresponding to an output of a detection process operating on a radar signal delivered by a maritime observation radar, the method implementing a tracking process for identifying a detection of the list of detections likely to be a spike, the tracking process being a hierarchical tracking process consisting, at a lower level, of tracking spikes, and, at a higher level, of tracking groups of spikes, the tracking of spikes at the lower level being performed conditionally upon the higher level based on a common parameter, the common parameter characterizing a track associated to a group of spikes.

2. The method according to claim 1, wherein the tracking process is performed by implementing a multi-group multi-spike tracking algorithm, the output of said algorithm being a high-level estimated random finite set, said set indicating, for each detection of the list of detections, the likelihood of being a spike.

3. The method according to claim 1, wherein the common parameter is a speed of the group of spikes and/or a wavelength of the group of spikes.

4. The method according to claim 1, wherein one spike is a phenomenon on the sea surface that gives rise to one or more powerful radar echoes, these radar echoes leading to an entry in the list of detections.

5. The method according to claim 1, wherein the tracking process is based on the assumption that spikes result from one or more swell trains.

6. The method according to claim 1, wherein the list of detections is a list of primary detections delivered at the output of the detection process or a list of secondary detections delivered at the output of another automatic false alarm control method.

7. The method according to claim 1, delivering a list of spike detections, each detection in the list of spike detections having a likelihood of being a spike greater than a predefined cutoff threshold.

8. The method according to claim 7, wherein each detection in the list of spike detections includes at least a position and advantageously by a speed, a likelihood of being a spike, a cardinal of the group of spikes to which the detection belongs, and/or a persistence of a track associated to the group of spikes to which the detection belongs.

9. A method for processing a radar signal delivered by a maritime observation radar, including:
applying a detection process to the radar signal to produce a list of primary detections;
applying a set of automatic false alarm control methods to confirm the list of primary detections and obtain a list of confirmed detections;
applying a target tracking method on the list of confirmed detections and/or adjusting configuration parameters of the detection process based on the result of applying the set of automatic false alarm control methods,
said set of automatic false alarm control methods including at least one method according to claim 1.

10. A computer-readable medium storing software instructions that implement the method according to claim 1, when executed by a computer of a maritime observation radar system.
